(19) United States
(12) Patent Application Publication
(10) Pub. No.: US 2019/0377429 A1
(43) Pub. Date: Dec. 12, 2019

(54) Active Writing Instrument

(71) Applicant: Leohab Enterprise Co., Ltd., Taichung City (TW)

(72) Inventor: Chao-Chi Lin, Taichung City (TW)

(21) Appl. No.: 16/003,228

(22) Filed: Jun. 8, 2018

(51) Int. Cl. G06F 3/0354

(52) U.S. Cl. CPC G06F 3/03545; H02J 7/0052

(57) ABSTRACT

An active writing instrument includes a first element, a second element pivotably connected to the first element, and a pivotal device mounted between the first element and the second element. The pivotal device includes a first seat connected to the first element, a second seat connected to the second element and pivotably connected to the first seat, a guiding member pivotably connected to the first seat, a sliding member movably connected to the guiding member, and a connector connected to the sliding member. The sliding member is movable relative to the guiding member in response to pivotal movement between the second seat and the first seat, thereby selectively exposing the connector outside of the second element.

### BACKGROUND OF THE INVENTION

The present invention relates to a writing instrument and, more particularly, to an active writing instrument.

A type of currently available active stylus pen can generate and send a signal to a touch pad, and an electronic device receives the signal and identifies the area touched by the active stylus pen based on the signal. Thus, a power source must be provided inside the active stylus pen to send the signal.

Taiwan Utility Model No. M530983 discloses an active stylus pen including a pivotal device having a connecting interface located more adjacent to a rear tube portion than a front tube portion. The connecting interface is exposed via the rear tube portion. FIG. 3 of this patent document shows that the connecting interface is exposed to an end of a pressing rod protruding out of the rear tube portion. When the electricity of the active stylus pen is insufficient, the connecting interface must be connected via a USB charging cable to an external power source for charging purposes.

However, a user using the above charging method must carry an extra USB charging cable, and the connecting interface exposed to the end of the pressing rod protruding out of the rear tube portion adversely affects the appearance or causes inconvenience in use. Thus, it is an important issue to solve the problems of the conventional techniques.

### BRIEF SUMMARY OF THE INVENTION

The present invention provides an active writing instrument for proceeding with transmission (such as power transmission, information transmission, etc.) without the need of carrying an extra cable. Furthermore, the connector of the active writing instrument is not exposed when in use, maintaining an aesthetic appearance.

An active writing instrument according to the present invention includes a first element, a second element pivotably connected to the first element, and a pivotal device mounted between the first element and the second element. The pivotal device includes a first seat connected to the first element, a second seat connected to the second element and pivotably connected to the first seat, a guiding member pivotably connected to the first seat, a sliding member movably connected to the guiding member, and a connector connected to the sliding member. The sliding member is movable relative to the guiding member in response to pivotal movement between the second seat and the first seat, thereby selectively exposing the connector outside of the second element.

In an example, the active writing instrument further includes an electrical energy storage element mounted to the first element and electrically connected to the connector.

In an example, the connector is a universal serial bus connector and is configured to be electrically connected to a universal serial bus socket for charging the electrical energy storage element via at least one cable.

In an example, the second element includes a top face and an opening defined in the top face. The connector is selectively exposed outside of the opening. The pivotal device further includes an elastic element having two ends respectively abutting the top face and the sliding member. The sliding member moves relative to the guiding member in response to the pivotal movement between the second seat and the first seat and compresses the elastic element.

In an example, the elastic element is a compression spring.

In an example, the first seat includes a spherical groove, and the guiding member includes a ball-shaped end rotatably received in the spherical groove.

In an example, the first seat includes a first coupling slot intercommunicating with the spherical groove. The guiding member includes a second coupling slot defined in the ball-shaped end. The pivotal device further includes a limiting member coupled with the first coupling slot and the second coupling slot, such that the ball-shaped end pivots in response to the pivotal movement between the second seat and the first seat.

In an example, the first seat includes a first engaging portion and a first coupling groove annularly disposed in an outer periphery of the first engaging portion. The spherical groove and the first coupling slot are formed on the first engaging portion. The first coupling groove is partially exposed to an outer periphery of the first seat. The second seat includes a second engaging portion engaged with the first engaging portion and a second coupling groove annularly disposed in the second engaging portion. The pivotal device further includes an engaging member coupled with the first coupling groove and the second coupling groove to pivotally connect the first seat and the second seat.

In an example, the guiding member includes at least one guiding portion helically extending along an outer periphery of the guiding member. The sliding member includes a coupling hole extending therethrough and at least one first guiding rib formed on an inner periphery of the coupling hole. An end of the coupling hole receives the guiding member. Another end of the coupling hole is securely connected to the connector. The at least one first guiding rib moves along the at least one guiding portion in response to the pivotal movement between the second seat and the first seat to thereby move the sliding member relative to the guiding member, such that the connector is selectively exposed outside of the opening of the second element.

In an example, the second element includes a plurality of guiding grooves disposed in an inner periphery of the second element and spaced from each other in a circumferential direction. The sliding member includes a plurality of second guiding ribs formed on the outer periphery of the sliding member. The plurality of second guiding ribs moves along the plurality of guiding grooves in response to the pivotal movement between the second seat and the first seat.

In an example, the first element extends along a first axis. The second element extends along a second axis and is pivotable relative to the first element to switch the active writing instrument between an in-use position and a charging position. The first axis and the second axis are coincident with each other when the active writing instrument is in the in-use position, and wherein the first axis is at an angle of 90° to the second axis when the active writing instrument is in the charging position.

In an example, the first element includes a first engaging groove annularly disposed in an inner periphery of the first element. The second element includes a second engaging groove annularly defined in an inner periphery of the second element. The first seat includes a first inclined face and a first engaging portion annularly disposed on an outer periphery of the first seat. The first engaging portion securely engages with the first engaging groove. The second seat includes a second inclined face facing the first inclined face. The second seat further includes a second coupling portion annularly disposed on an outer periphery of the second seat. The second coupling portion securely engages with the second engaging groove.

Thus, in the active writing instrument according to the present invention, the sliding member moves relative to the guiding member in response to the second seat and the first seat, such that the connector is selectively exposed outside of the second element. Thus, a charging cable is not required for the active writing instrument according to the present invention during charging. Specifically, cables for transmitting power and information are not required. Furthermore, the connector is not exposed when the active writing instrument is in use, maintaining an aesthetic appearance.

The present invention will become clearer in light of the following detailed description of illustrative embodiments of this invention described in connection with the drawings.

### DESCRIPTION OF THE DRAWINGS

FIG. 1 is a perspective view of an active writing instrument of an embodiment according to the present invention in an in-use position.

FIG. 2 is an exploded, perspective view of the active writing instrument of FIG. 1.

FIG. 3 is a partial, enlarged, cross sectional view of the active writing instrument of FIG. 1.

FIG. 4 is a partial, enlarged, cross sectional view of the active writing instrument of FIG. 1.

FIG. 5 is a view similar to FIG. 4, with a second element of the active writing instrument pivoted relative to a first element of the active writing instrument.

FIG. 6 is a partial, enlarged, cross sectional view of the active writing instrument of FIG. 1.

FIG. 7 is a partial, enlarged, cross sectional view of the active writing instrument of FIG. 1.

FIG. 8 is another perspective view of the active writing instrument according to the present invention in a charging position.

### DETAILED DESCRIPTION OF THE INVENTION

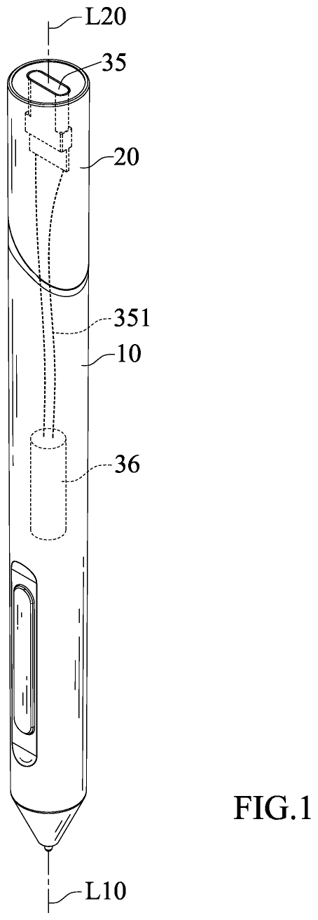

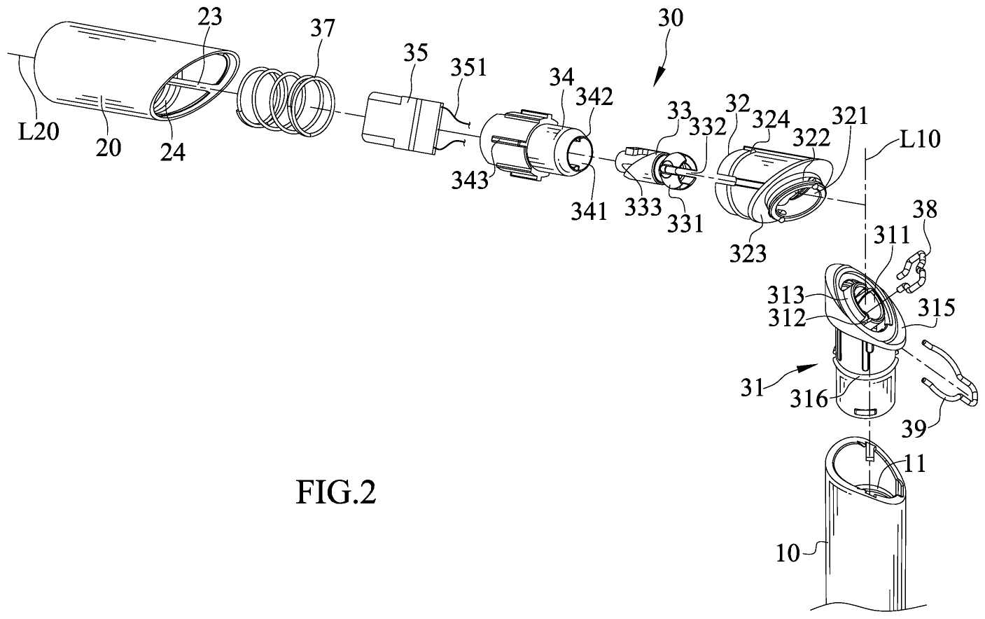

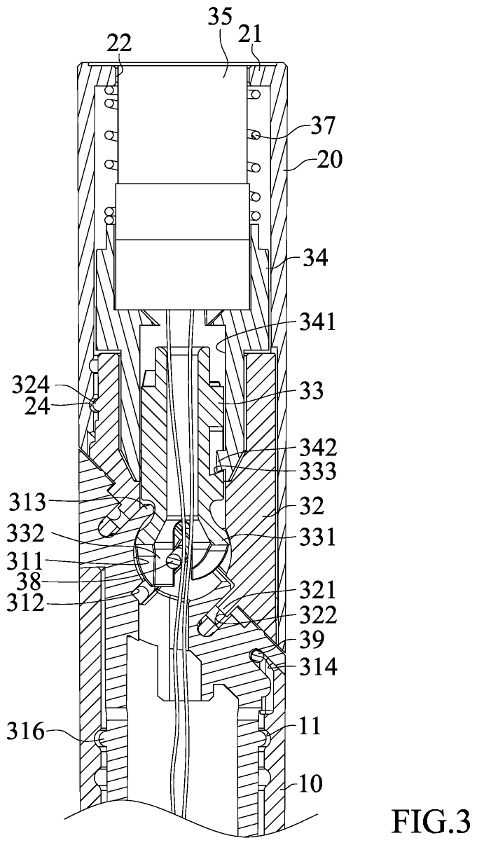

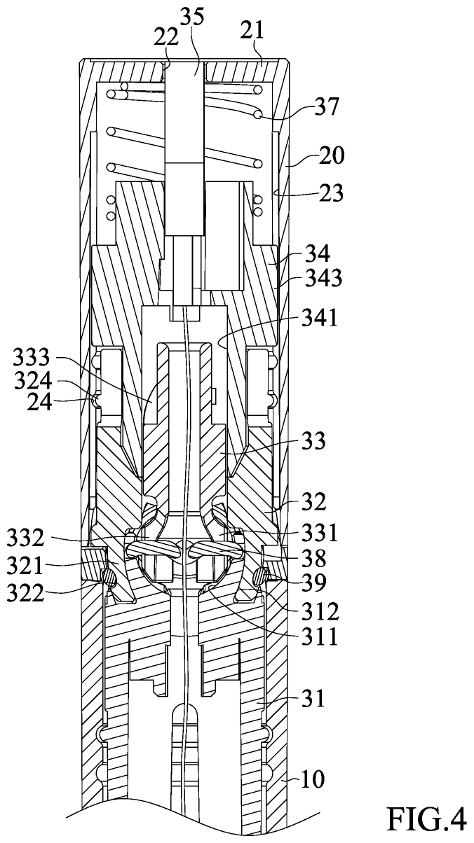

With reference to FIGS. 1-4, an active writing instrument of an embodiment according to the present invention includes a first element 10, a second element 20 pivotably connected to the first element 10, and a pivotal device 30 mounted between the first element 10 and the second element 20.

The first element 10 extends along a first axis L10 and includes a first engaging groove 11 annularly disposed in an inner periphery of the first element 10. A circuit board (not shown) is mounted in the first element 10 and can generate a signal transmittable through the first element 10 to an electronic device. The electronic device receiving the signal identifies an area touched by the first element 10 based on the signal sent by the first element 10.

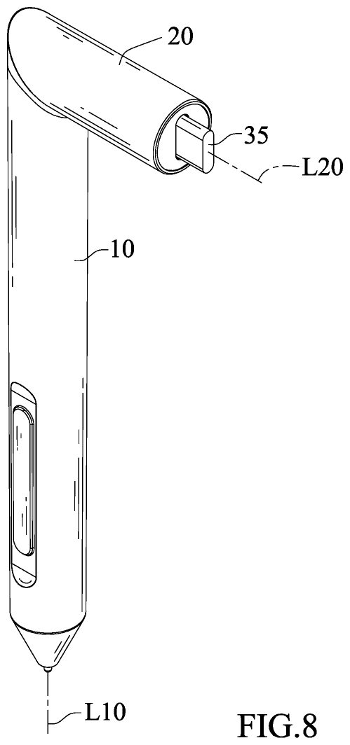

The second element 20 extends along a second axis L20 and is pivotable relative to the first element 10 to switch the active writing instrument between an in-use position and a charging position. The first axis L10 and the second axis L20 are coincident with each other when the active writing instrument is in the in-use position. The first axis L10 is at an angle of 90° to the second axis L20 when the active writing instrument is in the charging position, and the pivotal device 30 is exposed outside of the second element 20 (see FIG. 8).

The second element 20 includes a top face 21, an opening 22, a plurality of guiding grooves 23, and a second engaging groove 24. The opening 22 is defined in the top face 21. The plurality of guiding grooves 23 is disposed in an inner periphery of the second element 20, spaced from each other in a circumferential direction, and extends in a direction parallel to the second axis L20. The second engaging groove 24 is annularly defined in an inner periphery of the second element 20.

The pivotal device 30 includes a first seat 31 connected to the first element 10, a second seat 32 connected to the second element 20 and pivotably connected to the first seat 31, a guiding member 33 pivotably connected to the first seat 31, a sliding member 34 movably connected to the guiding member 33, and a connector 35 connected to the sliding member 34.

The first seat 31 includes a spherical groove 311, a first coupling slot 312 intercommunicating with the spherical groove 311, a first engaging portion 313, a first coupling groove 314 annularly disposed in an outer periphery of the first engaging portion 313, a first inclined face 315, and a first coupling portion 316 annularly disposed on an outer periphery of the first seat 31. The spherical groove 311 and the first coupling slot 312 are formed on the first engaging portion 313. The first engaging portion 313 is formed on the first inclined face 315. The first coupling groove 314 is partially exposed to an outer periphery of the first seat 31. The first coupling portion 316 is securely fixed in the first engaging groove 11 to securely connect the first seat 31 to the first element 10.

The second seat 32 includes a second engaging portion 321 engaged with the first engaging portion 313, a second coupling groove 322 annularly disposed in the second engaging portion 321, a second inclined face 323 facing the first inclined face 315, and a second coupling portion 324 annularly disposed on an outer periphery of the second seat 32. The second coupling portion 324 securely engages with the second engaging groove 24 to securely connect the second seat 32 to the second element 20.

The guiding member 33 includes a ball-shaped end 331 rotatably received in the spherical groove 31, a second coupling slot 332 defined in the ball-shaped end 331, and at least one guiding portion 333. When the active writing instrument is in the in-use position, the ball-shaped end 331 is in an initial position relative to the spherical groove 311. At least one guiding portion 333 helically extends along an outer periphery of the guiding member 33. In this embodiment, the guiding member 33 includes a pair of guiding portions 333 diametrically disposed on the guiding member 33.

The sliding member 34 is movably mounted around the guiding member 33 along the second axis L20. The sliding member 34 includes a coupling hole 341 extending therethrough, at least one first guiding rib 342 formed on an inner periphery of the coupling hole 341, and a plurality of second guiding ribs 343 formed on the outer periphery of the sliding member 34. An end of the coupling hole 341 movably receives the guiding member 33, such that the sliding member 34 is movable along the second axis L20 relative to the guiding member 33. Another end of the coupling hole 34 is securely connected to the connector 35, such that when the sliding member 34 moves relative to the guiding member 33 along the second axis L20, the connector 35 is synchronously actuated to move relative to the second element 20 along the second axis L20 and is selectively exposed outside of the opening 22 of the second element 20. The at least one first guiding rib 342 moves along the at least one guiding portion 333 in response to the pivotal movement between the second seat 32 and the first seat 31 to thereby move the sliding member 34 relative to the guiding member 33 along the second axis L20. In this embodiment, sliding member 34 includes a pair of first guiding ribs 342 diametrically disposed on the inner periphery of the coupling hole 341 and abutting the pair of guiding portions 333. A plurality of second guiding ribs 343 is formed on the outer periphery of the sliding member 34, is spaced from each other in a circumferential direction, and extends in a direction parallel to the second axis L20. The plurality of second guiding ribs 343 is slidably received in the plurality of guiding grooves 23. Thus, the plurality of second guiding ribs 343 respectively moves along the plurality of guiding grooves 23 in response to the pivotal movement between the second seat 32 and the first seat 31.

The connector 35 is securely received in the coupling hole 341 of the sliding member 34. When the active writing instrument is in the in-use position, the connector 35 is not exposed outside of the opening 22 of the second element 20. In this embodiment, the connector 35 can be a universal serial bus (USB) connector and is configured to be electrically connected to a universal serial bus socket for charging an electrical energy storage element 36 via at least one cable. Alternatively, the connector 35 can be a USB type-C or any USB coupler, such as a Mini-USB or a Micro-USB.

The electrical energy storage element 36 is mounted to the first element 10 and is electrically connected to the connector 35. The electrical energy storage element 36 is configured to supply electricity to the circuit board in the first element 10. In this embodiment, the electrical energy storage element 36 is a rechargeable battery.

The pivotal device 30 further includes an elastic element 37, a limiting member 38, and an engaging member 39. The elastic element 37 has two ends respectively abutting the top face 21 and the sliding member 34. The sliding member 34 moves relative to the guiding member 33 along the second axis L20 in response to the pivotal movement between the second seat 32 and the first seat 31 and compresses the spring 37. When the active writing instrument switches from the charging position to the in-use position, the elasticity of the elastic element 37 pushes the sliding member 34, such that the first guiding ribs 342 push the guiding portions 33, causing rotation of the ball-shaped end 331 relative to the spherical groove 311 back to its initial position.

In this embodiment, the elastic element 37 is a compression spring. The limiting member 38 couples with the first coupling slot 312 and the second coupling slot 332, such that the ball-shaped end 331 can proceed with rotational and pivotal movement relative to the spherical groove 311 in a limited angular range. The engaging member 39 is coupled with the first coupling groove 314 and the second coupling groove 322 to pivotally connect the first seat 31 and the second seat 32.

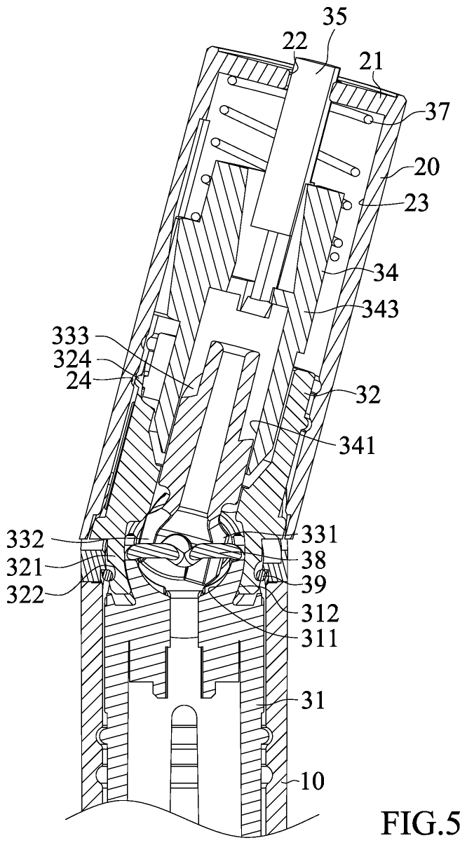

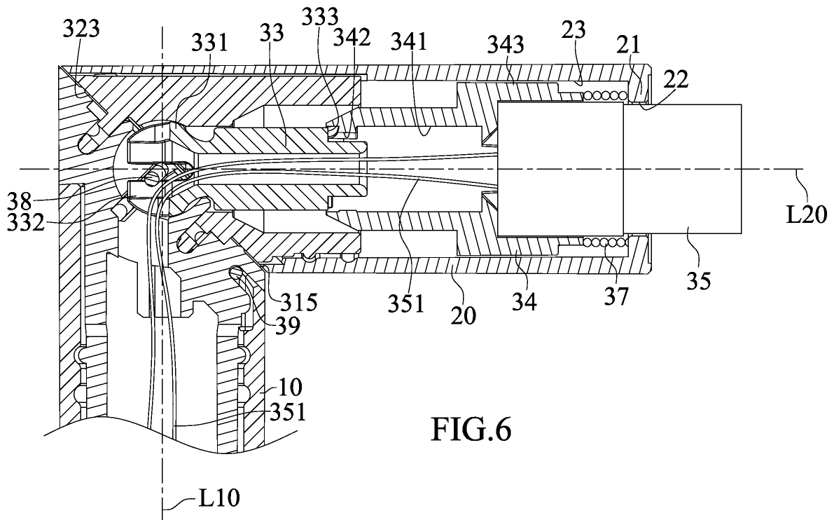

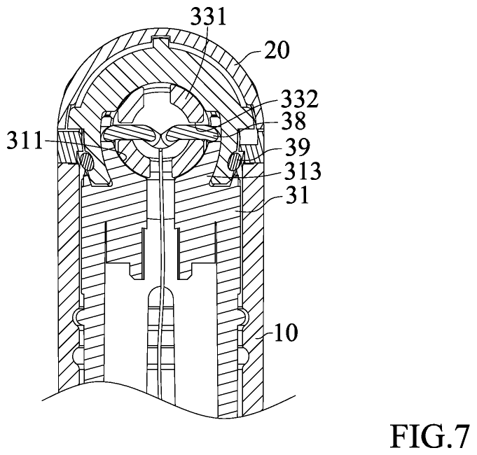

With reference to FIGS. 5-8, the second element 20 pivots relative to the first element 10 to switch the active writing instrument from the in-use position to the charging position. When the second element 20 starts to pivot relative to the first element 10, the second element 20 actuates the guiding member 33 to rotate and pivot relative to the first seat 31, such that the sliding member 34 slides relative to the guiding member 33 along the second axis L20 in response to the pivotal movement between the second seat 32 and the first seat 31. The first guiding ribs 342 of the sliding member 34 move along the guiding portions 333, the second guiding ribs 342 move along the guiding grooves 23, and the elastic element 37 is compressed by the sliding member 34.

When the second element 20 continues to pivot relative to the first element 10 to a position in which the angle between the first axis L10 and the second axis L20 is 90°, the active writing instrument is in the charging position. By moving the sliding member 34 relative to the guiding member 33 along the second axis L20 to synchronously move the connector 35 to move relative to the second element 20 along the second axis L20, the connector 35 is exposed outside of the opening 22 of the second element 20 for coupling with a socket for charging purposes.

On the other hand, when the second element 20 pivots relative to the first element 10 to switch the active writing instrument from the charging position to the in-use position, the elasticity of the elastic element 37 pushes the sliding member 34, such that the first guiding ribs 342 push the guiding portions 33. Thus, the ball-shaped end 331 rotates relative to the spherical groove 311 back to the initial position.

In view of the foregoing, in the embodiment of the active writing instrument according to the present invention, the sliding member 34 moves relative to the guiding member 33 in response to the second seat 32 and the first seat 31, such that the connector 35 is selectively exposed outside of the second element 20. Thus, a charging cable is not required for the active writing instrument according to the present invention during charging. Specifically, cables for transmitting power and information are not required. Furthermore, the connector 35 is not exposed when the active writing instrument is in use, maintaining an aesthetic appearance.

Although specific embodiments have been illustrated and described, numerous modifications and variations are still possible without departing from the scope of the invention. The scope of the invention is limited by the accompanying claims.

1. An active writing instrument comprising:
a first element;
a second element pivotably connected to the first element; and
a pivotal device mounted between the first element and the second element, wherein the pivotal device includes a first seat connected to the first element, a second seat connected to the second element and pivotably connected to the first seat, a guiding member pivotably connected to the first seat, a sliding member movably connected to the guiding member, and a connector connected to the sliding member, wherein the sliding member is movable relative to the guiding member in response to pivotal movement between the second seat and the first seat, thereby selectively exposing the connector outside of the second element.

2. The active writing instrument as claimed in claim 1, further comprising an electrical energy storage element mounted to the first element and electrically connected to the connector.

3. The active writing instrument as claimed in claim 2, wherein the connector is a universal serial bus connector and is configured to be electrically connected to a universal serial bus socket for charging the electrical energy storage element via at least one cable.

4. The active writing instrument as claimed in claim 1, wherein the second element includes a top face and an opening defined in the top face, wherein the connector is selectively exposed outside of the opening, wherein the pivotal device further includes an elastic element having two ends respectively abutting the top face and the sliding member, wherein the sliding member moves relative to the guiding member in response to the pivotal movement between the second seat and the first seat and compresses the elastic element.

5. The active writing instrument as claimed in claim 4, wherein the elastic element is a compression spring.

6. The active writing instrument as claimed in claim 1, wherein the first seat includes a spherical groove, and wherein the guiding member includes a ball-shaped end rotatably received in the spherical groove.

7. The active writing instrument as claimed in claim 6, wherein the first seat includes a first coupling slot intercommunicating with the spherical groove, wherein the guiding member includes a second coupling slot defined in the ball-shaped end, wherein the pivotal device further includes a limiting member coupled with the first coupling slot and the second coupling slot, such that the ball-shaped end pivots in response to the pivotal movement between the second seat and the first seat.

8. The active writing instrument as claimed in claim 7, wherein the first seat includes a first engaging portion and a first coupling groove annularly disposed in an outer periphery of the first engaging portion, wherein the spherical groove and the first coupling slot are formed on the first engaging portion, wherein the first coupling groove is partially exposed to an outer periphery of the first seat, wherein the second seat includes a second engaging portion engaged with the first engaging portion and a second coupling groove annularly disposed in the second engaging portion, wherein the pivotal device further includes an engaging member coupled with the first coupling groove and the second coupling groove to pivotally connect the first seat and the second seat.

9. The active writing instrument as claimed in claim 4, wherein the guiding member includes at least one guiding portion helically extending along an outer periphery of the guiding member, wherein the sliding member includes a coupling hole extending therethrough and at least one first guiding rib formed on an inner periphery of the coupling hole, wherein an end of the coupling hole receives the guiding member, wherein another end of the coupling hole is securely connected to the connector, wherein the at least one first guiding rib moves along the at least one guiding portion in response to the pivotal movement between the second seat and the first seat to thereby move the sliding member relative to the guiding member, such that the connector is selectively exposed outside of the opening of the second element.

10. The active writing instrument as claimed in claim 9, wherein the second element includes a plurality of guiding grooves disposed in an inner periphery of the second element and spaced from each other in a circumferential direction, wherein the sliding member includes a plurality of second guiding ribs formed on the outer periphery of the sliding member, wherein the plurality of second guiding ribs moves along the plurality of guiding grooves in response to the pivotal movement between the second seat and the first seat.

11. The active writing instrument as claimed in claim 1, wherein the first element extends along a first axis, wherein the second element extends along a second axis and is pivotable relative to the first element to switch the active writing instrument between an in-use position and a charging position, wherein the first axis and the second axis are coincident with each other when the active writing instrument is in the in-use position, and wherein the first axis is at an angle of 90° to the second axis when the active writing instrument is in the charging position.

12. The active writing instrument as claimed in claim 1, wherein the first element includes a first engaging groove annularly disposed in an inner periphery of the first element, wherein the second element includes a second engaging groove annularly defined in an inner periphery of the second element, wherein the first seat includes a first inclined face and a first engaging portion annularly disposed on an outer periphery of the first seat, wherein the first engaging portion securely engages with the first engaging groove, wherein the second seat includes a second inclined face facing the first inclined face, wherein the second seat further includes a second coupling portion annularly disposed on an outer periphery of the second seat, and wherein the second coupling portion securely engages with the second engaging groove.
